(19) United States
(12) Patent Application Publication
(10) Pub. No.: US 2007/0045239 A1
(43) Pub. Date: Mar. 1, 2007

(54) Apparatus and method for processing a microfeature workpiece using a plasma

(75) Inventor: Theodore M. Taylor, Boise, ID (US)

Correspondence Address: PERKINS COIE LLP;PATENT-SEA, PO BOX 1247, SEATTLE, WA, 98111-1247, US

(73) Assignee: Micron Technology, Inc., Boise, ID (US)

(21) Appl. No.: 11/217,162

(22) Filed: Aug. 31, 2005

(51) Int. Cl. B23K 9/00; B23K 9/02

(52) U.S. Cl. 219/121.5

(57) ABSTRACT

Apparatus and methods for processing microfeature workpieces in a plasma reactor. One embodiment of a plasma reactor includes a reaction vessel, a workpiece holder in the reaction vessel, and a gas distributor in the reaction vessel aligned with the workpiece holder. The gas distributor includes a plurality of first ports and a plurality of second ports. Additionally, individual second ports surround an immediately adjacent one of the first ports. The apparatus can further include a feed line coupled to at least one of the first ports and the second ports, and an exhaust line coupled to at least the other of the first ports and the second ports.

### TECHNICAL FIELD

The present invention generally relates to processing microfeature workpieces in the manufacturing of microelectronic and/or micromechanical devices. More specifically, several embodiments of the invention are directed to apparatus and methods for processing microfeature workpieces using a plasma.

### BACKGROUND

Etching and deposition procedures are widely used in the manufacturing of microelectronic and micromechanical devices to form features on a workpiece. The size of the individual components in the devices is decreasing and the number of layers in the devices is increasing. As a result, the density of the components and the aspect ratios of features is increasing to reduce the size of the individual dies and increase the performance. Moreover, the size of the workpieces is also increasing to provide more surface area for forming more dies on a single workpiece. Many fabricators, for example, are now using 300 mm workpieces, and even larger workpieces will likely be used in the future. As a result, deposition and/or etching techniques should produce highly uniform conformal layers, trenches, vias, holes, and other structures across the workpieces.

One widely used plasma process is plasma enhanced chemical vapor deposition (PECVD). Conventional plasma depositions systems typically include a processing vessel, a gas distributor, and a chuck. The gas distributor typically is one electrode and the chuck is often another electrode for forming a plasma. For example, the gas distributor and an electrostatic chuck can be biased at opposite potentials to generate a plasma proximate to the surface of the workpiece. In other plasma systems, microwave radiation passes through a window and into the reaction chamber to create a plasma.

Another plasma process is plasma etching. Plasma deposition processes and plasma etching processes are similar to each other and may use similar equipment, but plasma etching processes remove material from the workpiece instead of depositing material onto the workpiece. In plasma etching processes, the chemicals and/or the energy levels are generally different than those for plasma deposition processes.

One challenge of both plasma deposition and plasma etching processes is providing a uniform distribution of gas across the surface of the workpiece. Many conventional gas distributors, for example, feed the gas from outlets above the wafer such that the gas flows downwardly and across the surface of the wafer. These systems generally exhaust the gas from the peripheral region of the wafer or from a region below the wafer. This causes a net radial outward flux of the gas from the center of the wafer that produces concentration gradients of the feed gases and byproducts. As a result, conventional gas distributors and exhaust systems in plasma reactors can produce a non-uniform distribution of the feed gas species (e.g., a radial gas flow pattern).

To overcome the problems associated with plasma reactors that exhaust the feed gas from the periphery of the wafer, other existing gas distributors have supply and exhaust apertures arranged in a checkerboard pattern or in linear slots. Although these gas distributors improve the uniformity of the gas distribution across the surface of the wafer, it may be desirable to further improve the uniformity of the gas distribution for producing the small, high-density components required in current high performance devices. Therefore, there is a need to develop a gas distribution system for plasma processing reactors that provides, a highly uniform and controlled gas distribution across the surface of the workpiece.

### BRIEF DESCRIPTION OF THE DRAWINGS

FIG. 1 is a schematic illustration of a plasma processing system in accordance with an embodiment of the invention.

FIG. 2 is a bottom plan view of a gas distributor of the embodiment of the plasma processing system illustrated in FIG. 1.

FIG. 3 is a plasma processing system in accordance with another embodiment of the invention.

FIG. 4 is a schematic illustration of the embodiment of the plasma processing system illustrated in FIG. 3 in an alternate configuration.

FIG. 5 is a schematic illustration of a plasma processing system during a processing cycle in accordance with another embodiment of the invention.

FIG. 6 is a schematic illustration of an embodiment of the plasma processing system shown in FIG. 5 in a load/unload configuration.

### DETAILED DESCRIPTION

### A. Overview

The present invention is directed toward apparatus and methods for processing a microfeature workpiece using a plasma. Several embodiments of the present invention, more specifically, are directed toward providing a uniform gas flow across the surface of the workpiece in a plasma reactor. As a result, several embodiments of the apparatus and methods in accordance with the invention are expected to enhance the quality and control of manufacturing small components in microfeature devices.

One aspect of the invention is directed toward tools for processing microfeature workpieces. An embodiment of such an apparatus includes a reaction vessel, a workpiece holder in the reaction vessel, and a gas distributor in the reaction vessel aligned with the workpiece holder. The gas distributor includes a plurality of first ports and a plurality of second ports, and individual second ports surround an immediately adjacent one of the first ports. The apparatus can further include a gas supply line coupled to at least one of the first ports and the second ports, and an exhaust line coupled to at least the other of the first ports and the second ports.

The first ports can comprise feed ports and the second ports-can comprise exhaust ports. Additionally, in one embodiment the gas supply line is coupled to only the first ports and the exhaust line is coupled to only the second ports. In another embodiment, the gas supply line is coupled to both the first and second ports, and the apparatus further includes a plurality of feed valves that independently control the flow of feed gas through the first ports and the second ports. In this embodiment, the exhaust line can also be coupled to both the first ports and the second ports, and the apparatus further includes a plurality of exhaust valves that independently control the flow of exhaust gases through the first ports and the second ports. In several embodiments, the first and second ports can be alternating annular openings or channels exposed to the workpiece holder. In still further embodiments, the apparatus can comprise a perimeter barrier configured to move with respect to the gas distributor between a process position in which the barrier completely encloses a workpiece between the gas distributor and the workpiece, and a load/unload position in which a workpiece can be handled by automated handling equipment.

Another embodiment of an apparatus for plasma processing of a microfeature workpiece comprises a reaction vessel, a workpiece holder in the reaction vessel, and a gas distributor in the reaction vessel aligned with the workpiece holder. The gas distributor includes a plurality of circular feed ports and a plurality of circular exhaust ports that are arranged concentrically with respect to each other. The feed ports and exhaust ports can also alternate with each other along a radius relative to the workpiece. This embodiment of the apparatus further includes a gas supply line coupled to the feed ports and an exhaust line coupled to the exhaust ports.

Still another embodiment of an apparatus for plasma processing in accordance with the invention comprises a reaction vessel, a workpiece holder in the reaction vessel, and a gas distributor in the reaction vessel aligned with the workpiece holder. The gas distributor in this embodiment has a plurality of feed ports and a plurality of exhaust ports such that the feed ports are configured to concurrently dispense the feed gas to annular feed regions on the workpiece and the exhaust ports are configured to remove the gases from annular exhaust regions relative to the workpiece.

Another aspect of the invention is directed toward methods for processing a microfeature workpiece using a plasma. One embodiment of such a method includes flowing a feed gas through a plurality of first ports and onto the workpiece, and drawing the gases up from the workpiece and into a plurality of second ports. The individual second ports surround an immediately adjacent one of the first ports. The method continues by generating a plasma between the first ports and the workpiece.

Another embodiment of a method of processing a microfeature workpiece using a plasma comprises dispensing a feed gas onto concentric annular feed regions of the workpiece, and vacuuming the gas from the workpiece by drawing an exhaust gas into annular exhaust regions. The exhaust regions are adjacent to the annular feed regions. This method further includes generating a plasma between the feed ports and the workpiece.

Still another embodiment of a method for processing a microfeature workpiece using a plasma comprises dispensing a feed gas through a plurality of first ports and onto the workpiece for a first dispense cycle, and drawing the feed gas up from the workpiece and into a plurality of second ports during the first dispense cycle. This method further includes dispensing the feed gas through the second ports and onto the workpiece for a second dispense cycle, and drawing the feed gas up from the workpiece and into the first ports during the second dispense cycle. This method further includes generating a plasma adjacent to the workpiece during the first dispense cycle and/or the second dispense cycle.

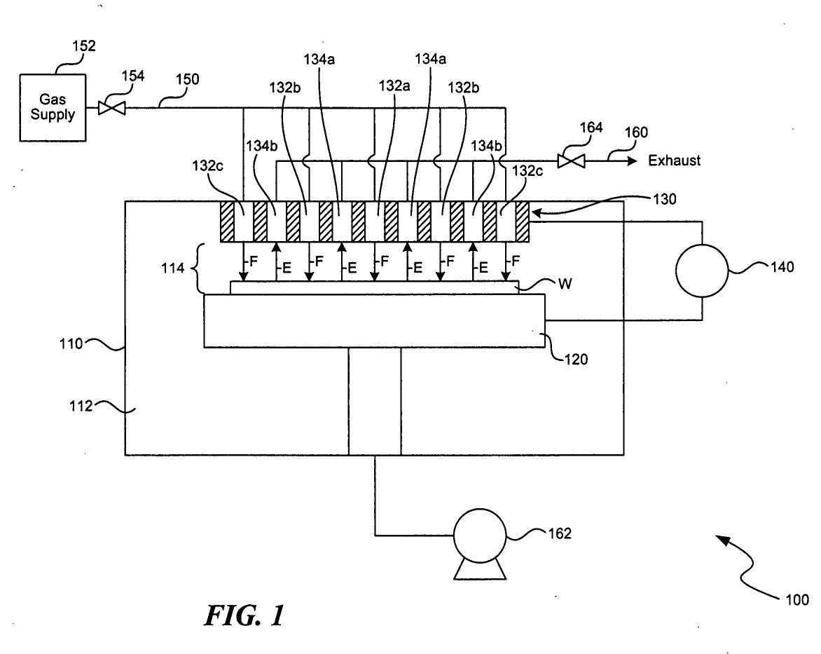

FIGS. 1-5 illustrate several systems and methods for processing a microfeature workpiece using a plasma. Specific details of the invention are set forth in the following description and in FIGS. 1-5 to provide a thorough understanding of these embodiments of the invention. One skilled in the art, however, will understand that the present invention may have additional embodiments, or that other embodiments of the invention may be practiced without several of the specific features explained in the following description. The term “microfeature workpiece” is used throughout to include substrates upon which and/or in which microelectronic devices, micromechanical devices, data storage elements, micro optics, microbiological devices, and other features are fabricated. For example, microfeature workpieces can be semiconductor workpieces, glass substrates, dielectric substrates, or many other types of substrates. Many features on such microfeature workpieces have critical dimensions less than or equal to 1 μm, and in many applications the critical dimensions of the smaller features are less than 0.25 μm or even less than 0.1 μm. Where the context permits, singular or plural terms may also include the plural or singular term, respectively. Moreover, unless the word “or” is expressly limited to mean only a single item exclusive from other items in reference to a list of at least two items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same features and/or types of other features and components are not precluded.

### B. Embodiments of Processing Microfeature Workpieces Using a Plasma

FIG. 1 is a schematic view illustrating a plasma reactor 100 in accordance with an embodiment of the invention. In this embodiment, the plasma reactor 100 includes a reaction vessel 110 having a chamber 112 with a plasma zone 114 in which a plasma is created to process a workpiece W. The plasma reactor 100 further includes a workpiece holder 120 configured to hold the workpiece W and a gas distributor 130 configured to dispense a feed gas in the plasma zone 114. The gas distributor 130 is generally aligned with or otherwise juxtaposed to the workpiece holder 120. The plasma reactor 100 can further include a power supply 140 electrically coupled to the workpiece holder 120 and the gas distributor 130. In operation, the power supply 140 biases the workpiece holder 120 and the gas distributor 130 with opposite potentials such that the workpiece W acts as a working electrode and the gas distributor 130 acts as a counter-electrode. As explained in more detail below, the gas distributor 130 is configured to provide a uniform or otherwise controlled distribution of feed gas relative to the surface of the workpiece W to enhance plasma etching and/or plasma deposition processes.

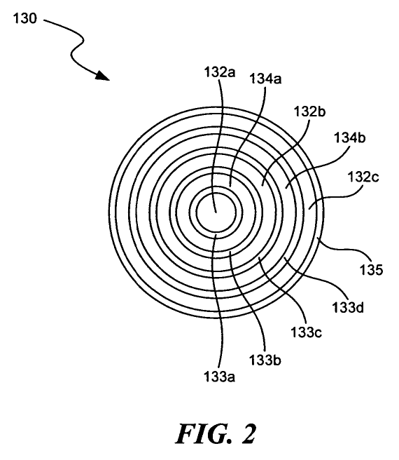

FIG. 2 is a bottom plan view of the gas distributor 130 shown in FIG. 1. Referring to FIGS. 1 and 2 together, the gas distributor 130 has a plurality of first ports 132 (identified individually by reference numbers 132a-132c) and a plurality of second ports 134 (identified individually by reference numbers 134a and 134b). The first and second ports 132 and 134 are slots, channels or other features that can distribute and/or withdraw a gas in the plasma zone 114. In the embodiment illustrated in FIGS. 1 and 2, the first ports 132 and the second ports 134 are circular slots or channels arranged concentrically with respect to each other such that the first and second ports 132 and 134 alternate with each other along a radius of the workpiece W. Alternatively, each first port 132 and each second port 134 can be a circular row of a plurality of holes. The ports 132 and 134 can define individual annular regions relative to the surface of the workpiece W. In one embodiment, several of the second ports 134- surround immediately adjacent interior first ports 132. For example, the second port 134a surrounds the first port 132a, and the second port 134b surrounds the first port 132b. The adjacent first and second ports 132 and 134 can be separated from one another by partitions 133 (identified individually by reference numbers 133a-133d in FIG. 2). The outer port, in this case the first port 132c, is enclosed by an outer wall 135 (FIG. 2).

The plasma reactor 100 further includes a feed line 150 and an exhaust line 160. In the embodiment illustrated in FIG. 1, the feed line 150 is operatively coupled to the first ports 132a-c such that these ports are dedicated feed ports for delivering a feed gas to the workpiece W. The feed line 150 can be coupled to a gas supply 152 via a feed valve 154 for controlling the flow of a feed gas from the gas supply 152 to the first ports 132a-c. The exhaust line 160 can be coupled to the second ports 134a-b to draw exhaust gases from the plasma zone 114 through the second ports 134a-b. The exhaust line 160 can be coupled to a pump 162 via a valve 164 to create a lower pressure in the second ports 134 than the first ports 132.

In operation, the feed valve 154 opens to flow the feed gas F through the first ports 132a-c and onto annular regions of the workpiece W, and the exhaust valve 164 opens to create a flow of exhaust gas E through the second ports 134. The operation of the feed valve 154 and the exhaust valve 160 can be controlled to provide a continuous flow of feed gas F through the first ports 132 and a continuous flow of exhaust gas E through the exhaust ports 134 during a plasma cycle. In alternative embodiments, the feed valve 154 and the exhaust valve 160 can be opened and closed in a predetermined sequence that provides pulses of the feed gas F through the first ports 132 and pulses of exhaust gas E through the second ports 134, or instead of pulses the feed valve 154 and the exhaust valve 160 can be operated for continuous variable flows through the first and second ports 132 and 134. As the feed gas F is dispensed/exhausted in the plasma zone, the power supply biases the workpiece holder W and the gas distributor 130 to generate a plasma.

One advantage of several embodiments of the plasma reactor 100 is that the gas distributor 130 is expected to provide a highly uniform flow of feed gas relative to the surface of the workpiece W. The illustrated embodiment of the gas distributor 130, more specifically, dispenses the feed gas in a plurality of annular zones such that the concentrations of feed gas at the central and perimeter regions of the workpiece W are at desirable levels. In many embodiments, the flow of feed gas through the first port 132a over the center of the workpiece W and the flow of feed gas through the first port 132c proximate to the perimeter of the workpiece W can be controlled such that the concentration of the feed gas is at least substantially the same at the center and perimeter regions of the workpiece W. Moreover, embodiments of the invention that have circular, concentric first and second ports 132 and 134 are further expected to enhance the uniformity of the feed gas because the configuration of the gas distributor corresponds to the circular shape of most workpieces. Therefore, several embodiments of the plasma reactor 100 are expected to enhance the ability to provide a uniform, controlled flow of feed gas over a workpiece in the manufacturing of microfeature devices.

### C. Additional Embodiments of Plasma Processing Apparatus and Methods

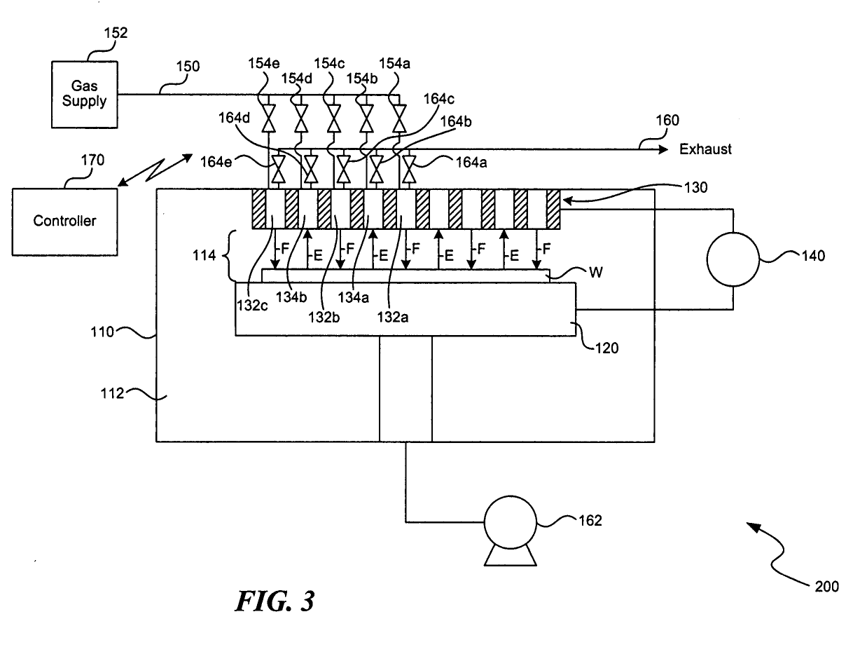

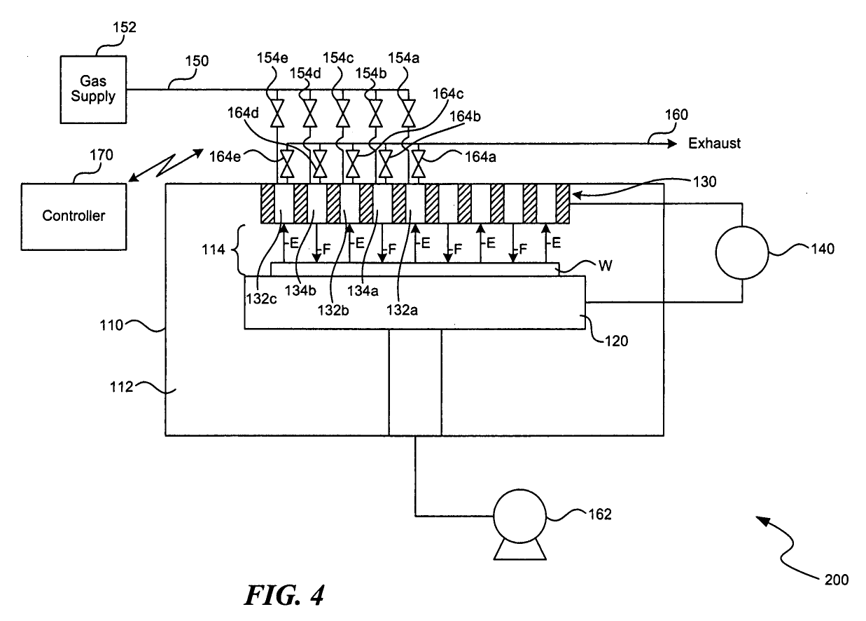

FIG. 3 schematically illustrates a plasma reactor 200 in accordance with another embodiment of the invention, and FIG. 4 schematically illustrates the apparatus 200 at a different stage of operation. The plasma reactor 200 shown in FIGS. 3 and 4 is similar to the plasma reactor 100 illustrated in FIGS. 1 and 2, and thus like reference numbers refer to like components in FIGS. 1-4. The plasma reactor 200 includes a plurality of feed valves 154a-e and a plurality of exhaust valves 164a-e. The feed valves 154a-e couple the feed line 150 to individual first ports 132a-c and individual second ports 134a-b. Similarly, the exhaust valves 164a-e couple the exhaust line 160 to individual first ports 132a-c and individual second ports 134a-b. The feed valves 154a-e and the exhaust valves 164a-e can be operatively coupled to a controller 170 to operate the valves in a manner that provides the desired feed zones and exhaust zones relative to the workpiece W.

FIGS. 3 and 4 illustrate one embodiment of operating the plasma reactor 200. FIG. 3, more specifically, shows the plasma reactor during a first dispense cycle in which the controller 170 opens the feed valves 154a, 154c, and 154e, and closes the exhaust valves 164a, 164c, and 164e. This causes feed gas F to flow through the first ports 132a, 132b and 132c. As such, the feed zones during the first dispense cycle are annular areas on the workpiece W under the first ports 132a, 132b, and 132c. The controller 170 also closes the feed valves 154b and 154d and-opens the exhaust valves 164b and 164d during the first dispense cycle to vacuum exhaust gases E from the plasma zone through the second ports 134a-b. This configuration accordingly provides the same feed zones and exhaust zones relative to the workpiece W as the plasma reactor 100 illustrated in FIG. 1. However, unlike the plasma reactor 100, the plasma reactor 200 can be controlled to reconfigure the feed zones and exhaust zones relative to the workpiece W.

FIG. 4 illustrates the plasma reactor 200 during a second dispense cycle in which the feed zones and exhaust zones have been reconfigured. More specifically, the controller closes the feed valves 154a, 154c, and 154e and opens the exhaust valves 164a, 164c and 164e to draw exhaust gases E through the first ports 132a-c, and the controller 170 opens the feed valves 154b and 154d and closes the exhaust valves 164b and 164d to dispense the feed gas F through the second ports 134a-b. The feed zones are accordingly under the second ports 132a-b during the second dispense cycle. The plasma reactor 200 can provide any number of different configurations of feed zones and exhaust zones relative to the workpiece W by opening/closing the feed valves 154a-e and the exhaust valves 164a-e. Several embodiments of the plasma reactor 200 can accordingly provide a controlled concentration of feed gas relative to different radial locations across the workpieces. For example, the concentration at the center can be higher than the perimeter for forming seed layers so that the seed layers are thicker at the center than the perimeter of the workpiece W.

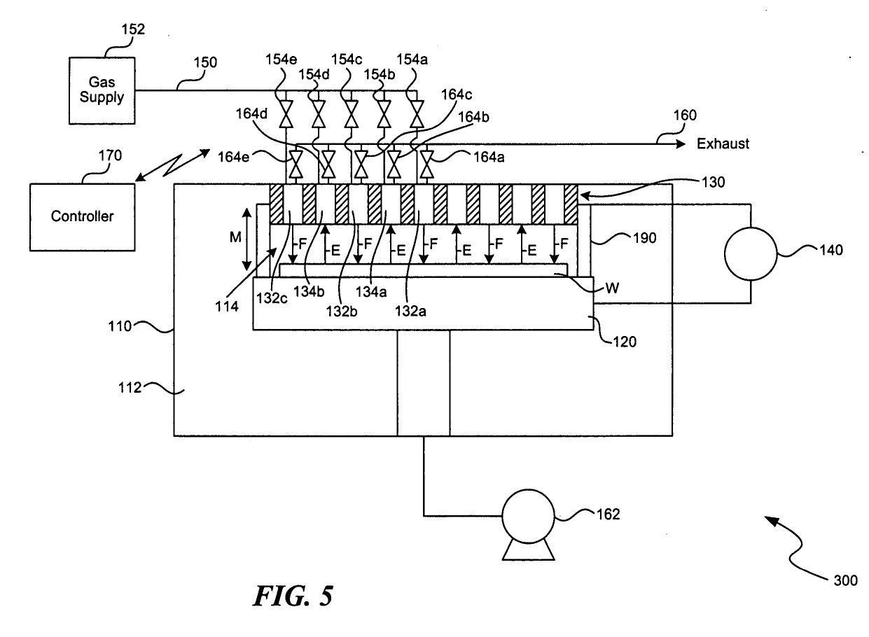

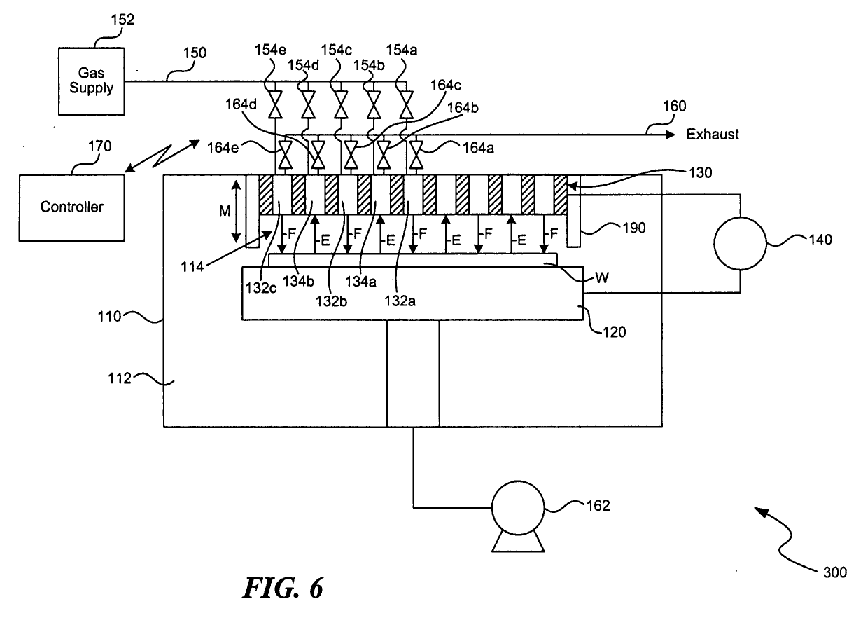

FIGS. 5 and 6 schematically illustrate a plasma reactor 300 in accordance with still another embodiment of the invention. The plasma reactor 300 can be similar to the plasma reactor 200 illustrated in FIGS. 3 and 4, and thus like reference numbers refer to like components in FIGS. 1-6.

The plasma reactor 300 can further include a barrier 190 extending around the perimeter of the gas distributor 130 and/or the workpiece holder 120. The barrier 190, for example, can be a perimeter skirt or wall that is movably attached to the gas distributor to move toward and away from the workpiece holder 120. The barrier 190 c an be driven by actuators that are controlled by the controller 170 to work in coordination with the feed valves 154 and the exhaust valves 164. In alternative embodiments, the barrier 190 can remain in a fixed position and the workpiece holder 120 can move toward and away from the gas distributor 130.

FIG. 5 illustrates the plasma reactor 300 with the barrier 190 in a process position in which the workpiece W is completely enclosed in the plasma zone 114 between the gas distributor 130 and the workpiece holder 120. The controller 170 then configures the valves in a desired configuration to feed and exhaust the gases within the plasma zone 114. For example, the controller 170 can control the feed valves 154a-e and the exhaust valves 164a-e such that the gas distributor 130 dispenses and exhausts the gases as described above with reference to FIG. 3. FIG. 6 illustrates the plasma reactor 300 when the barrier has been raised to a load/unload position in which the workpiece W can be handled by automated handling equipment. In the load/unload position, the processing zone 114 is opened to allow ingress/egress of the workpiece W. Additionally, the controller 170 can control the feed valves 154a-e and the exhaust valves 164a-e to exhaust gases through all of the first ports 132a-c and the second ports 132a-b in the load/unload position.

In alternative embodiments of the plasma reactors 100, 200 and 300, the gas distributor can have any number of suitable first and second ports for dispensing/exhausting gases relative to the workpiece W. Additionally, any of the features of the embodiments illustrated in FIGS. 1-6 can be combined with each other in additional embodiments. For example, the barrier of the plasma reactor 300 shown in FIGS. 5 and 6 can be combined with the plasma reactor 100 illustrated in FIG. 1. In still further embodiments, the walls of the first ports 132 and/or the second ports 134 can be heated to inhibit deposits within the ports. The reactor can include a heating element in or near the gas distributor in such an embodiment.

From the foregoing, it will be appreciated that specific embodiments of the invention have been described herein for purposes of illustration, but that various modifications may be made without deviating from the spirit and scope of the invention. For example, the controller can be operated to control the feed valves and/or the exhaust valves to provide different feed rates and exhaust rates in zones relative to the workpiece. Accordingly, the invention is not limited except as by the appended claims.

I/We claim:

1. An apparatus for plasma processing of a microfeature workpiece, comprising:
a reaction vessel;
a workpiece holder in the reaction vessel;
a gas distributor in the reaction vessel aligned with the workpiece holder, the gas distributor including a plurality of first ports and a plurality of second ports, wherein individual second ports surround an immediately adjacent one of the first ports;
a feed line coupled to at least one of the first ports and the second ports; and
an exhaust line coupled to at least the other of the first ports and the second ports.

2. The apparatus of claim 1 wherein:
the first ports comprise feed ports and the second ports comprise exhaust ports; and
the feed line is coupled to the feed ports and the exhaust line is coupled to the exhaust ports.

3. The apparatus of claim 1 wherein:
the feed line is coupled to the first ports and second ports, and the apparatus has a plurality of feed valves that independently control the flow of feed gas to the first ports and second ports; and
the exhaust line is coupled to the first ports and second ports, and the apparatus further includes a plurality of exhaust valves that independently control the flow of exhaust gases from the first ports and second ports.

4. The apparatus of claim 1, further comprising a power supply operatively coupled to the gas distributor and the workpiece holder to establish an electrical field between gas distributor and the workpiece holder.

5. The apparatus of claim 1, further comprising a perimeter barrier configured to move with respect to the gas distributor, wherein the perimeter barrier is configured to move between a process position in which the barrier completely encloses a workpiece between the gas distributor and the workpiece holder and a load/unload position in which a workpiece can be handled by automated handling equipment.

6. The apparatus of claim 1, further comprising:
a gas supply coupled to the feed line;
a pump coupled to the exhaust line; and
a computer operatively coupled to a feed valve in the feed line and an exhaust valve in the exhaust line, wherein the computer operable medium contains instructions that cause (a) a feed gas to pass from the gas supply and through the first ports and (b) a low pressure in the exhaust line to exhaust gases through the second ports.

7. The apparatus of claim 6, further comprising a plurality of feed valves that independently control the flow of feed gas to the first ports and second ports and a plurality of exhaust valves that independently control the flow of exhaust gases from the first ports and second ports, and wherein the computer operable medium contains instructions that operate the feed valves and the exhaust valves such that (a) the first ports can dispense a feed gas and the second ports can exhaust the feed gas for a first period, and (b) the second ports can dispense the feed gas and the first ports can exhaust the feed gas for a second period.

8. The apparatus of claim 1 wherein the first ports comprise first circular openings aligned with an axis of the gas distributor and the second ports comprise second circular openings concentrically aligned with the first circular ports.

9. An apparatus for plasma processing of a microfeature workpiece, comprising:
a reaction vessel;
a workpiece holder in the reaction vessel;
a gas distributor in the reaction vessel aligned with the workpiece holder, the gas distributor having a plurality of circular feed ports and a plurality of circular exhaust ports, wherein the feed ports and the exhaust ports are arranged concentrically;
a gas supply line coupled to the feed ports; and
an exhaust line coupled to the exhaust ports.

10. The apparatus of claim 9 wherein:
the apparatus has a plurality of feed valves that independently control the flow of feed gas to the feed ports and the exhaust ports; and
the apparatus further includes a plurality of exhaust valves that independently control the flow of exhaust gases from the feed ports and exhaust ports.

11. The apparatus of claim 9, further comprising a power supply operatively coupled to the gas distributor and the workpiece holder to establish an electrical field between gas distributor and the workpiece holder.

12. The apparatus of claim 9, further comprising a perimeter barrier moveable with respect to the gas distributor, wherein the perimeter barrier is configured to move between a process position in which the barrier completely encloses a workpiece between the gas distributor and the workpiece holder and a load/unload position in which a workpiece can be handled by automated handling equipment.

13. The apparatus of claim 9, further comprising:
a gas supply coupled to the gas supply line;
a pump coupled to the exhaust line; and
a computer operatively coupled to the gas supply line and the exhaust line, wherein the computer operable medium contains instructions that cause (a) a feed gas to pass from the gas supply and through the feed ports and (b) a low pressure in the exhaust line to exhaust the feed gas through the exhaust ports.

14. The apparatus of claim 13, further comprising a plurality of feed valves that independently control the flow of feed gas to the feed ports and the exhaust ports and a plurality of exhaust valves that independently control the flow of exhaust gases from the feed ports and exhaust ports, and wherein the computer operable medium contains instructions that operate the feed valves and the exhaust valves such that (a) the feed ports can deposit a feed gas and the exhaust ports can exhaust the feed gas for a first period, and (b) the exhaust ports can dispense the feed gas and the feed ports can exhaust the feed gas for a second period.

15. The apparatus of claim 9 wherein the feed ports comprise first circular orifices aligned with an axis of the gas distributor and the exhaust ports comprise second circular orifices concentrically aligned with the first circular ports.

16. An apparatus for plasma processing of a microfeature workpiece, comprising:
a reaction vessel;
a workpiece holder in the reaction vessel;
a gas distributor in the reaction vessel aligned with the workpiece holder, the gas distributor having a plurality of feed ports and a plurality of exhaust ports, wherein the feed ports are configured to concurrently feed gas to annular feed regions on the workpiece and the exhaust ports are configured to remove the feed gas from annular exhaust regions relative to the workpiece;
a gas supply line coupled to the feed ports; and
an exhaust line coupled to the exhaust ports.

17. The apparatus of claim 16 wherein:
the apparatus has a plurality of feed valves that independently control the flow of feed gas to the feed ports and the exhaust ports; and
the apparatus further includes a plurality of exhaust valves that independently control the flow of exhaust gases from the feed ports and exhaust ports.

18. The apparatus of claim 16, further comprising a power supply operatively coupled to the gas distributor and the workpiece holder to establish an electrical field between gas distributor and the workpiece holder.

19. The apparatus of claim 16, further comprising a perimeter barrier moveable with respect to the gas distributor, wherein the perimeter barrier is configured to move between a process position in which the barrier completely encloses a workpiece between the gas distributor and the workpiece holder and a load/unload position in which a workpiece can be handled by automated handling equipment.

20. The apparatus of claim 16, further comprising:
a gas supply coupled to the gas supply line;
a pump coupled to the exhaust line; and
a computer operatively coupled to the gas supply line and the exhaust line, wherein the computer operable medium contains instructions that cause (a) a feed gas to pass from the gas supply and through the feed ports and (b) a low pressure in the exhaust line to exhaust the feed gas through the exhaust ports.

21. The apparatus of claim 20, further comprising a plurality of feed valves that independently control the flow of feed gas to the feed ports and the exhaust ports and a plurality of exhaust valves that independently control the flow of exhaust gases from the feed ports and exhaust ports, and wherein the computer operable medium contains instructions that operate the feed valves and the exhaust valves such that (a) the feed ports can deposit a feed gas and the exhaust ports can exhaust the feed gas for a first period, and (b) the exhaust ports can dispense the feed gas and the feed ports can exhaust the feed gas for a second period.

22. The apparatus of claim 16 wherein the feed ports comprise first circular orifices aligned with an axis of the gas distributor and the exhaust ports comprise second circular orifices concentrically aligned with the first circular ports.

23. A method of processing a microfeature workpiece using a plasma, comprising:
flowing a feed gas through a plurality of first ports and onto the workpiece;
drawing gas up from the workpiece and into a plurality of second ports, wherein individual second ports surround an immediately adjacent one of the first ports; and
generating a plasma between the first ports and the workpiece.

24. The method of claim 23 wherein flowing the feed gas through the first ports comprises dispensing the feed gas through a plurality of annular feed ports, and wherein drawing gas up from the workpiece and into the second ports comprises vacuuming exhaust gases through a plurality of annular exhaust ports.

25. The method of claim 23 wherein:
the first ports and the second ports are circular openings arranged concentrically with respect to each other such that the first ports and the second ports alternate with each other along a radius relative to the workpiece;
flowing the feed gas through the first ports comprises dispensing the feed gas through the circular openings; and
drawing gas from the workpiece and into the second ports comprises vacuuming gases through the circular openings of the second ports.

26. The method of claim 23 further comprising:
terminating flowing the feed gas through the first ports;
terminating drawing gas from the workpiece through the second ports;
initiating flowing the feed gas through the second ports; and
initiating drawing gas from the workpiece through the first ports.

27. The method of claim 23 further comprising moving a perimeter barrier with respect to the workpiece to completely enclose the workpiece between a gas distributor and a workpiece holder in a processing position while flowing the feed gas through the first ports and drawing gas up from the workpiece through the second ports.

28. A method of processing a microfeature workpiece using a plasma, comprising:
dispensing a feed gas onto concentric annular feed regions of the workpiece;
vacuuming the feed gas from the workpiece by drawing the feed gas into annular exhaust regions adjacent to the annular feed regions; and
generating a plasma between the first ports and the workpiece.

29. The method of claim 28 wherein:
dispensing the feed gas onto concentric annular feed regions of the workpiece comprises flowing the feed gas through a plurality of circular first ports; and
vacuuming the feed gas from the workpiece comprises drawing gas up from the workpiece and into a plurality of second ports.

30. The method of claim 29 wherein the first ports and the second ports are circular openings arranged concentrically with respect to each other such that the first ports and the second ports alternate with each other along a radius relative to the workpiece.

31. The method of claim 28 further comprising changing the location of the annular feed regions and the annular exhaust regions relative to the workpiece while generating a plasma.

32. A method of processing a microfeature workpiece using a plasma, comprising:
dispensing a feed gas through a plurality of first ports and onto the workpiece for a first dispense cycle;
drawing the feed gas up from the workpiece and into a plurality of second ports during the first dispense cycle;
dispensing the feed gas through the second ports and onto the workpiece for a second dispense cycle;
drawing the feed gas up from the workpiece and into the first ports during the second dispense cycle; and
generating a plasma adjacent to the workpiece.

33. The method of claim 32 wherein the first ports and the second ports are circular openings arranged concentrically with respect to each other and the first ports and the second ports alternate with respect to each other along a radius relative to the workpiece, and wherein dispensing the feed gas through the first ports comprises flowing the feed gas into annular feed regions generally aligned with the first ports.

34. The method of claim 33 wherein dispensing the feed gas through the second ports comprises flowing the feed gas through the second ports to form annular feed zones aligned with the second ports.
